(19) United States
(12) Patent Application Publication
(10) Pub. No.: US 2011/0259170 A1
(43) Pub. Date: Oct. 27, 2011

(54) SOUND POST INSERTING / REMOVING TOOL

(76) Inventor: KAROL SIWKO, Ocala, FL (US)

(21) Appl. No.: 13/106,756

(22) Filed: May 12, 2011

Related U.S. Application Data
(60) Provisional application No. 61/441,082, filed on Feb. 9, 2011.

(51) Int. Cl. G10D 1/02

(52) U.S. Cl. 84/277

(57) ABSTRACT

Violin Sound Post inserting tool with a handle having a spring type clamp attached at right angle. One half of the clamp has a groove or cradle into which sound post is placed. The second half is a spring plate which secures the Sound Post in the clamp. After the sound post has been introduced and firmly set inside the violin sound box the spring plate of the clamp can be deflected by pressure against the sound post, thus opening the clamp. Also the spring plate has extended lip beyond the cradle, thus with the clamp open the sprig part is made to slide along the sound post without interference from the cradle of the base plate.

### CROSS REFERENCE TO RELATED APPLICATIONS

This application claims the benefits of U.S. Provisional Patent Application No. 61/441,082, which is incorporated by reference herein.

### FIELD OF THE INVENTION

This invention relates to tools for inserting Sound Post into violins and other string instruments that include a Sound Post in their construction.

1. Related Prior Art

Existing patents reference: U.S. Pat. No. 6,482,239, U.S. Pat. No. 5,804,748, Also U.S. Pat. Nos. 1,466,681, 1,556,340 and 1,559,657, U.S. Pat. No. 470,778

2. Background

Existing patents reference: U.S. Pat. No. 6,482,239, U.S. Pat. No. 5,804,748, Also U.S. Pat. Nos. 1,466,681, 1,556,340 and 1,559,657, U.S. Pat. No. 470,778 All methods require either costly tools or high degree of skill and dexterity. U.S. Pat. No. 470,778, although it will not work with sound post, demonstrates that a component, (a screw) can be attached to a tool (screw driver) and easily released after proper placement.

Similar principle is applied in a tool designed to pick up and retrieve a sound post dropped inside a violin, but this also is useless for inserting the Sound Post. This invention describes a tool that will enable to grasp and hold a violin Sound Post, place it in required location and release it in controlled manner. This tool is also inexpensive and easy to use.

### SUMMARY

This invention provides a new approach of holding a sound post in the tool and releasing it upon insertion into the sound box of a violin or similar string instrument. The principle of operation is similar to that of spring loaded clamp, which is attached to a handle and is offset so it can reach a desired spot inside the violin sound box. One side of the clamp has indentation at its end to provide a cradle for the Sound Post. Second side is a Spring Plate applying pressure on the sound post, thus retaining it in the cradle. The Spring Plate is made longer to extend beyond the cradle of the first part and can also be deflected to open the clamp.

The Sound Post can then be moved and released by maneuvering the handle portion at the outside of the instrument sound box. The sound post movement can be achieved by either moving or tuning of the handle.

The unique part of this invention is that the sound post is held by the tool accurately, upon insertion is easily released, and the tool is easy to use. Further the construction of the tool is extremely simple and is easy to produce at much lower cost than currently available tools.

### BRIEF DESCRIPTION OF DRAWINGS

Drawing 1 Basic concept

Drawing 2 Operating Principle

Drawing 3 Sound Post placement inside violin sound box

Drawing 4 Various configurations of Base Plate

Drawing 5 Various configuration and attachment methods

Drawing 6 Options when both clamp sides are made from single spring strip.

Drawing 7 Cradle attached to handle extension

Drawing 8 Tool configurations

Following letters are assigned to identify these components in all drawings

‘A’ refers to Handle

‘B’ refers to Base Plate

‘C’ Refers to Spring Plate

‘D’ Refers to Sound Post

### Violin Sound Box

Main components of a violin and other similar string instrument include the Sound box, Finger board, Strings and Bridge. Tone or pitch of the sound is controlled by pressing the string against the finger board thus changing the effective length of the string. String is made to vibrate by plucking or bowing and transfers the sound through the Bridge to the top acoustic plate of the Sound Box, which amplifies and projects the sound. The inside of the top plate of the sound box is reinforced by a Bass Bar permanently glued under the bass side of the bridge. The Sound Post is inserted inside the Sound Box, between the top and bottom acoustic plates, under the treble leg of the bridge. This strengthens the violin and transfers sound vibrations to the bottom plate. The position of the Sound Post affects sound quality. Introducing the sound post through a relatively narrow hole in the top plate requires special tools. Existing tools either require skill and manual dexterity or are expensive. Generally this work has been left mostly to specialists.

### DETAILED DESCRIPTION

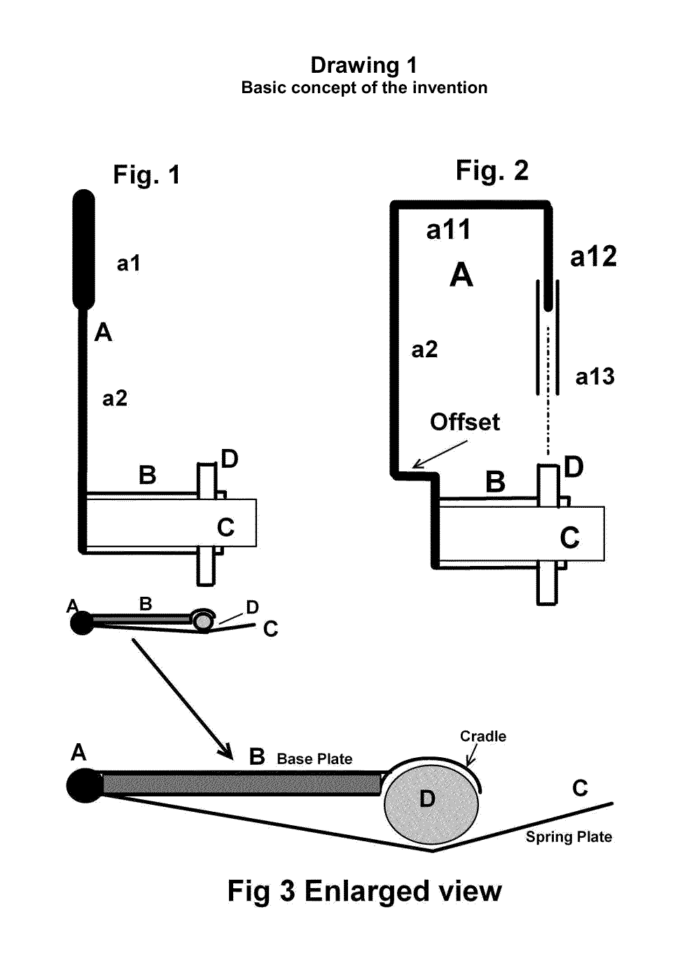

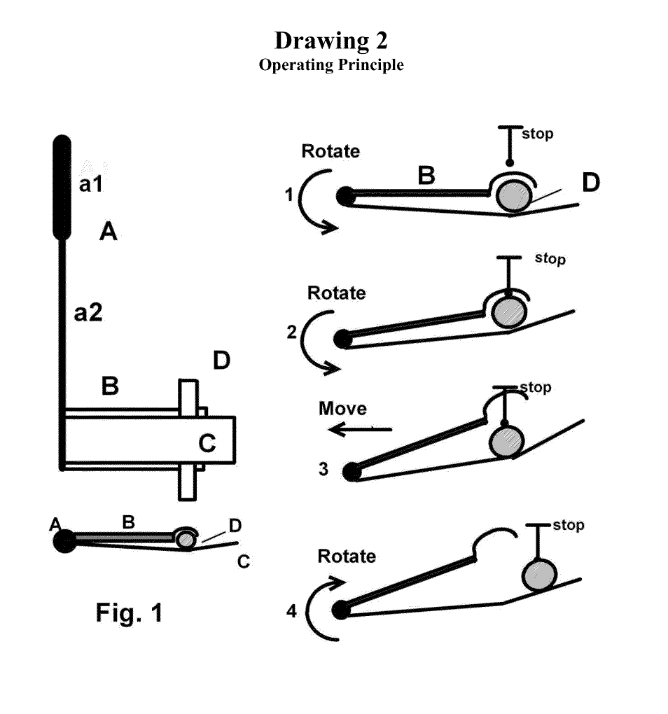

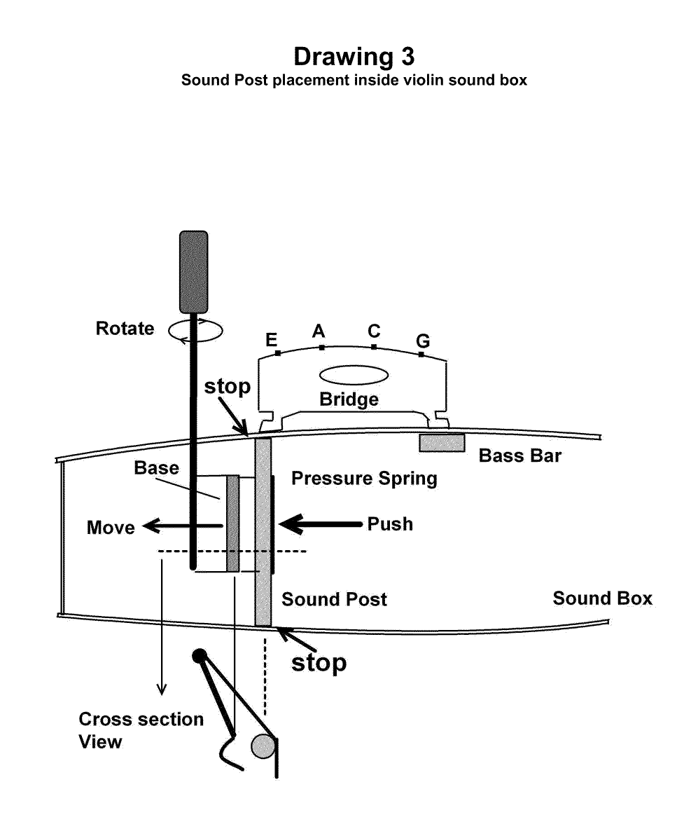

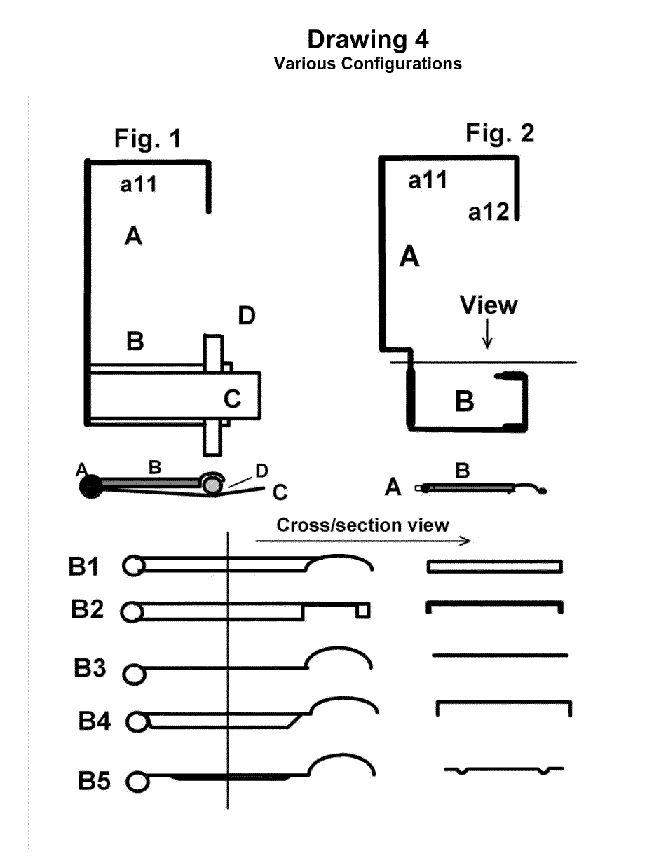

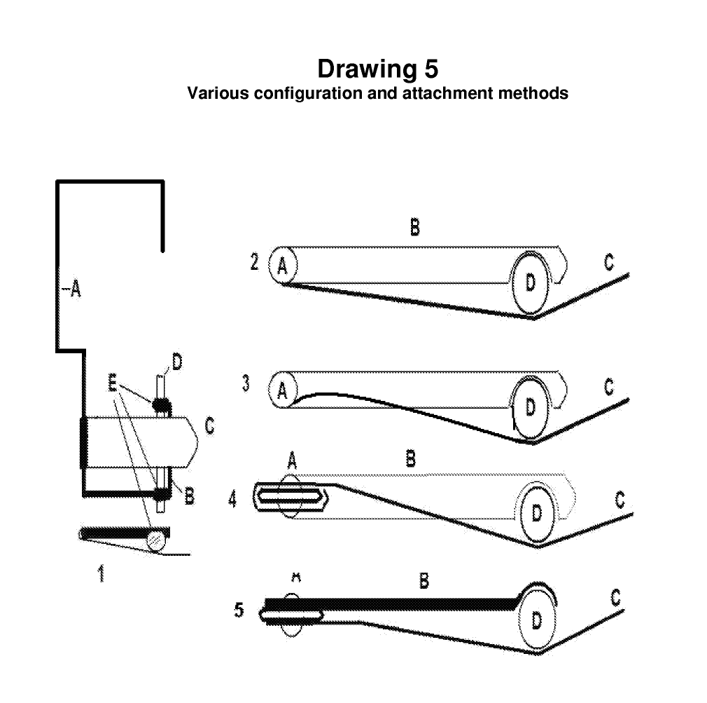

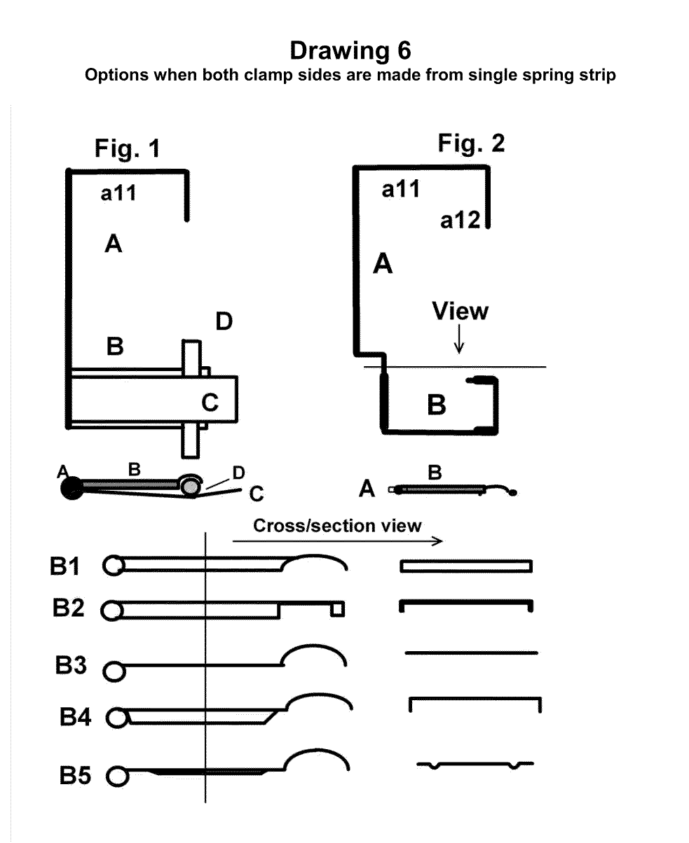

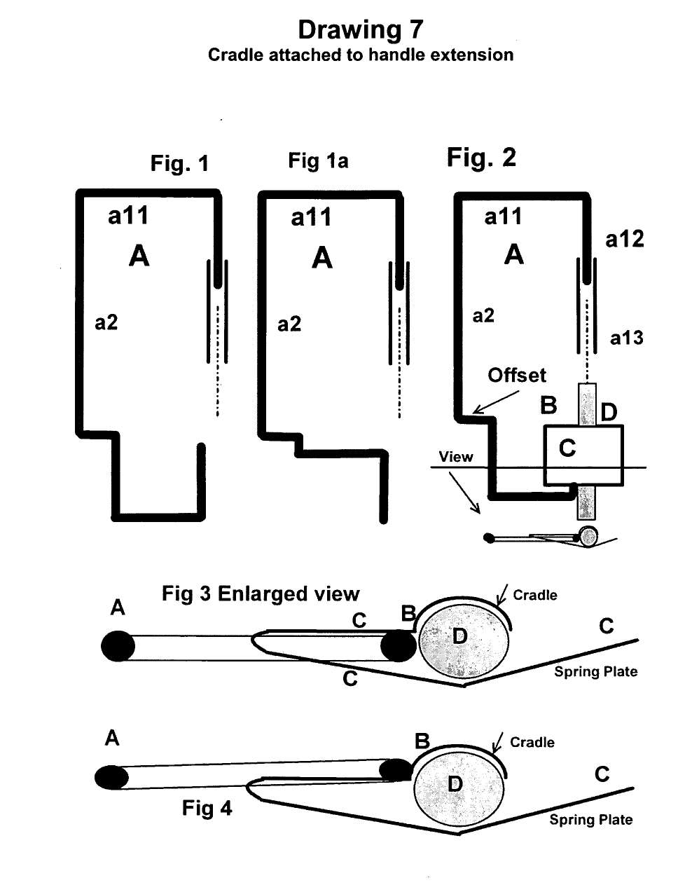

Basic construction is shown in Drawing 1. FIG. 1 and in FIG. 3, which is enlarged detail of top view.

It consists of preferably but not necessarily, fairly rigid base plate (B), having a groove (or cradle) to keep the sound post (D) in position. This base may be either rigid or flexible, rigid is preferable. A pressure Spring Plate (C) holds the Sound Post (D) in position until it is ready to be transferred and released in proper location. The Spring Plate is longer than the Base Plate is relatively smooth and capable to deflect under pressure. It can be either wire or strip, and can be either straight or bent as necessary. The two plates make up a Clamp which can hold a pin or a Sound Post in place. The drawing shows the Spring Plate to be narrower than the base plate, so it is easier to show the relationship of different parts. In fact the Spring Plate can be wider to improve stability. The Clamp is attached to a handle (A). The stem of the handle (a2) needs to be sufficiently rigid and thin, such that it can be easily maneuvered along relatively narrow S-hole of the instrument. The grip of the handle (a1) can be made thicker for convenience. Making the clamp so the sound post is substantially parallel to the stem of the handle allows the operator to more easily judge the angle and position of the sound post. With wire stem this angle can be modified to suit the user.

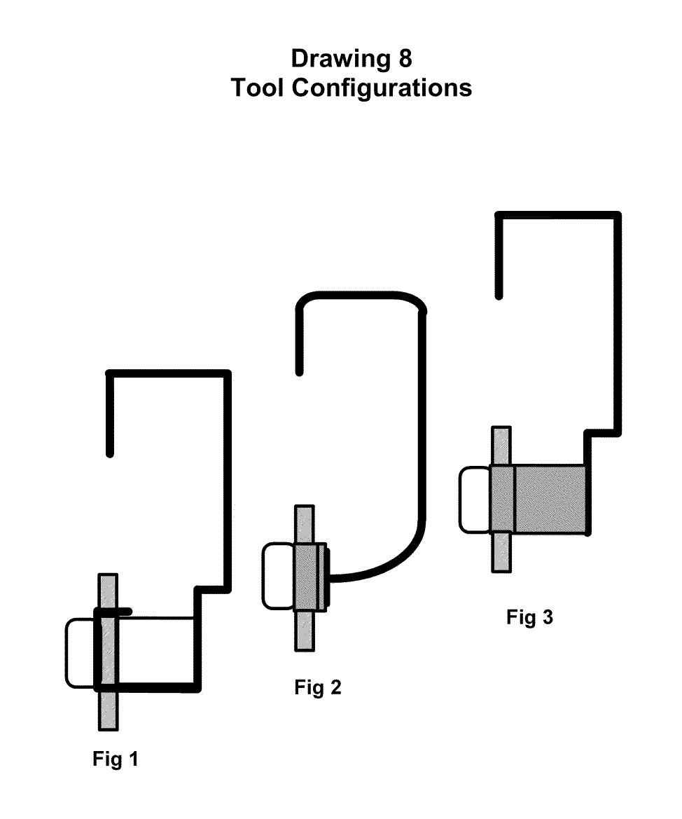

FIG. 2 in Drawing 1 shows one of many other alternative ways of making handle grip. Here by bending the top of the stem, (a11 and a12). Arm a12 points to the Sound Post, thus location of the Sound Post can be seen from outside the sound box. FIG. 2 also shows the handle stem a2 is bent with an offset. This provides dual reach inside violin sound box.

### Principle of Operation

Construction of the tool can be best explained by showing how it operates.

Drawing 2 helps explain the 4 steps to demonstrate the operation.

The Sound Post (D) is inserted into the tool and the assembly introduced inside the violin Sound Box. Positioning of sound post is controlled with the handle's lateral movement or by rotation.

### Step1.

The tool is rotated with handle (A) as pivot point as Sound Post is moved towards the target.

### Step2.

The rotation makes the Sound Post move towards an obstruction (stop), which is such that it will capture the Sound Post and prevent any further movement of the Sound Post, Which in turn prevent movement of the Spring Plate (C), but will not obstruct the movement of the tool Base Plate (B). The (“stop” points are also marked in Drawing 3, where further movement of sound post is stopped by decreased height inside the sound box). Further rotation will cause the Spring Plate (C) to deflect (bend) while the base plate is moved further to separate from the sound post, as shown in step 3.

### Step3.

The tool may now be moved laterally such that the base plate moves beyond the sound post.

### Step4.

The tool is now rotated in the opposite direction and withdrawn, leaving the Sound Post at the chosen location.

Procedure can be reversed to remove the Sound Post from inside the sound box. The protruding lip of the Spring Plate is pressed against the Sound Post thus opening the clamp, then the Spring plate is made to slide along the Sound Post to set it in line with the cradle of the Base Plate. Removing pressure will close the clamp.

Drawing 3 demonstrates how the invention works inside the instrument sound box. The sound box in string instruments such as violin, viola or cello, include top and bottom acoustic boards, bent outwards in middle. In case of violin the Sound Post is inserted close to the bridge below the E-string leg. Those skilled in the art are well aware of different parts and their function in violin.

First, Sound Post is placed in the tool between the Base Plate and Pressure Spring. If total assembly is too thick, the tool is first inserted into sound box and then the Sound Post inserted into tool through the S-hole.

Subsequently, by manipulating the handle, with lateral movement and rotation, the Sound Post is moved close to center of the instrument (the highest part of the instrument) and then slowly moved to the desired spot, where it fits exactly between top and bottom acoustic boards (this was defined as “stop” in Drawing 2, FIG. 3). The handle is then turned such that the Spring Plate applies gentle force to push the Sound Post till it is jammed between the two acoustic plates. When the handle is turned further, the Sound Post and the Spring Plate will not move, but the Base Plate will move and separate from Sound Post, thus freeing the Sound Post. The pressure spring is now free to slide along the Sound Post, and the base plate cradle is now moved away from the sound post far enough (As in Drawing 2, FIG. 3-4) so the Sound Post gets clear of the base plate and only stay in contact with the extended portion of the Pressure Spring; beyond the end of the base. Then the handle can be rotated in opposite direction and the tool removed, without disturbing the sound post that is now set in place.

### Construction Options

Drawing No.1, FIG. 2 shows how the handle rod may be bent in the grip area, (a11 and a21) to allow better grip. The handle can be bent further to point towards the sound post (a12); adding adjustable extension (a13) will make location of the sound post easily visible from outside of the instrument. Further the end portion can be sharpened to help pick up a dropped sound post. If the handle is made from non hardened material it can further be formed by the user to perform other functions.

Further the handle stem may also be bent (Drawing 1, FIG. 2a) above the Base Plate to provide offset to the working plates, thus giving variable reach for different size of violin or viola. If the handle is made of wire, it can also be bent and formed by the user.

Drawing 4 FIG. 1 shows basic construction. It also illustrates details of some of construction options of Base Plate.

FIG. B1, Base made of solid metal or plastic having a very thin cradle end.

B2 is metal or plastic extrusion having the cradle slot cut or formed.

B3 is simple base plate of thin material with end formed to make a cradle.

B4 is thin metal or plastic with edges bent to enhance rigidity.

B5 is thin metal with bumps pressed to increase rigidity.

With all these options the base plate is bonded, soldered, welded or attached to the handle with any established technique. The base plate and handle can also be molded as a single unit for low cost mass production.

### Preferred Embodiment

Integrated Handle and Base Plate.

Drawing 4 FIG. 2 demonstrates that a Handle and the Base Plate can be easily made out of single piece of wire, where grooves are cut or pressed to locate the sound post. Pressure Spring (C) can be attached to handle. Handle may be made either of metal or plastic.

Drawing 5 shows how a Pressure Spring Plate is attached to the handle stem

1. Integrated wire Handle and Base Plate are demonstrated, the wire is flattened (E) at two points to provide cradle for the Sound Post. Same attachment techniques can be used with other Base Plate construction.

2. Pressure Plate is attached directly to the stem.

3. Same as 2, but attached to a point inside the Base Plate body. This increases the spring pressure, thus allows use of thinner spring.

4. The Stem at the base is flattened and the Pressure Plate is preformed, then it is snapped on without welding.

5. The stiff Base Plate B can be preformed to have very thin cradle end and both plates are attached to the handle. This keeps the diameter around the Sound Post (D) at minimum, thus allowing problem free insertion into a narrow S-hole

Single Piece Blade Preferred Option

Details in Drawing 6 show yet another concept, which allows smaller overall tool thickness. Also the area around the sound post is kept at minimum. Here both Base Plate and Spring Plate are made of single piece of very thin metal, formed and bent to produce the Base with cradle and the Spring Plates. Detail 1 shows the preformed clamping plates. This clamp is attached or welded to the handle stem Details 2. Detail 3 shows the bottom part of the stem flattened to reduce the width and improve bonding or welding joint. Detail 3 also shows how the Base Plate can be stiffened either by adding thicker material or forming a rib along its length. Partial flattening of handle improves welding quality, while round wire enables flexibility to adjust plate angle relative to handle grip.

The handle can be flattened and formed to hold clamp blades without welding (detail 4 and detail 5).

Detail 6 has the end formed into a tight loop thus retaining the clamp. Details 7 and 8 show the end shaped into a fork or flat with similar results. This system makes the clamp removable and reversible.

Drawing 7 shows that the clamp can be attached at the cradle while most of the offset is done by forming the handle (FIG. 1). This will make shorter clamp assembly (FIG. 2). Spring plate is folded to increase its length (detail in FIG. 3). FIG. 4 shows alternate way of clamp assembly. This system can enable effect of stiffer Base Plate.

Drawing 8 shows three tools with different methods of construction. FIG. 1 Handle and Base Plate are integrated and formed from single piece of wire, second. FIG. 3 Base Plate and pressure Plate are integrated and made from a single piece of thin spring foil. Generally the foil Base plate will be thinner and allow easier insertion into the S slot. When integrated with wire handle, the Base Plate will generally be stiffer, thus allowing easier removal and resetting of Sound Post, but may need to be inserted into the violin S slot before accepting of the sound post. FIG. 2 shows that Handle stem can be formed and bent to increase reach of the tool and to allow shorter clamp. With wire stem, reach can be adjusted by the operator.

This does not exclude other methods of Base Plate and Pressure Plate construction which are both obvious and logical, and will combine cost and performance balance.

What is claimed is:

1. Sound post tool comprising of
A tool having a Handle
An offset clamp attached to handle
Clamp consists of Base Plate having indentation or cradle to accept a violin Sound Post and of Spring Plate to provide pressure, thus retain Sound Post in the tool. The Spring Plate is elongated to protrude beyond cradle part of Base Plate and is able to be deflected by moderate pressure to keep the clamp open. While under pressure from a Sound Post the tool can be made to slide along to embrace the Sound post to the cradle or to release from the cradle. Tool Handle provides means to control placement and position of the clamp holding the Sound Post, thus provides transport, release or pickup.

2. A tool as in claim 1 where the base plate while thicker, is made very thin at the cradle end to enable easy insertion it S-hole.

3. A tool as in claim 1, where the base plate is integral part of the handle.

4. A tool as in claim 1, where the spring plate and the cradle part of the base plate are very thin to enable inserting the tool holding the sound post into a tight S-hole.

5. A tool as in claim 1, where the base plate and spring plate are made from single thin strip and folded to produce clamp type assembly.

6. A tool as in claim 5, where the handle bottom end is formed into a tight loop to secure base and spring plates.

7. A tool as in claim 5, where the handle end is formed into a fork to secure base and spring plates.

8. A tool as in claim 5, where the handle is flattened at base plate and spring plate embracing the handle end.

9. A tool as in claim 5 where clamp is attached at the cradle edge.

10. A tool as in claim 1 where some or all parts are made of metal

11. A tool as in claim 1 where some or all parts are made of plastic.

12. A tool, as in all claims, having a handle bent with offset to provide dual reach option.

13. A tool as in all claims where the sound post cradle holds the Sound Post parallel with the stem of the Handle.

14. Tool as in all claims, in which top part of the handle is formed such that it points to the sound post cradle.

15. (canceled)

16. Tool as in claim 1 having different size to be used with sound post insertion in Viola

17. Tool as in claim 1 having different size to be used with sound post insertion in Cello

18. (canceled)

19. (canceled)

20. (canceled)

21. A tool as in claim 1 where base plate is made of thin material.

22. A tool as in claim 21 where thin material is formed to make the Base Plate more rigid.

23. A tool as in claim 5 where the handle stem is formed to extend offset for the clamp while shorter clamp is used.
